(19) United States
(12) Patent Application Publication
(10) Pub. No.: US 2017/0109774 A1
(43) Pub. Date: Apr. 20, 2017

(54) CUSTOMER LOYALTY PROGRAM ACROSS MULTIPLE SHOPPING CHANNELS

(71) Applicant: Wal-Mart Stores, Inc., Bentonville, AR (US)

(72) Inventors: Chandrashekar Natarajan, San Ramon, CA (US); Donald R. High, Noel, MO (US); Dhaval Gat, Bangalore (IN)

(21) Appl. No.: 15/293,330

(22) Filed: Oct. 14, 2016

Related U.S. Application Data
(60) Provisional application No. 62/241,964, filed on Oct. 15, 2015.

(51) Int. Cl. G06Q 30/02

(52) U.S. Cl. CPC G06Q 30/0227; G06Q 30/0255

(57) ABSTRACT

A loyalty transaction system and method comprise a member enrollment confirmation module that determines whether a store customer is a member of a loyalty program offered by the store; a channel determination module that communicates with a database to identify one or more channels available to the store customer for acquiring an item of interest, and determines whether the store customer as a member of the loyalty program uses the one or more channels to acquire the item of interest, the database storing records including data related to the one or more channels, associated customer purchase data, and incentive data corresponding to the channels; a matching module that processes the database records to determine a relationship between the item of interest and the one or more channels for acquiring the item of interest; a point recordation device that associates an incentive with the one or more channels when the item of interest is acquired; and a price comparator that outputs to an electronic device information about purchasing the item of interest from different channels of the one or more channels.

### RELATED APPLICATIONS

This invention claims priority to U.S. provisional patent application Ser. No. 62/241,964, filed Oct. 15, 2015, entitled “Customer Loyalty Program Across Multiple Shopping Channels”, which is included entirely herein by reference.

### FIELD

The present concepts relate generally to store customer loyalty programs, and more specifically, to systems and methods for cross-channel shopping and offering loyalty program incentives across multiple channels.

### BACKGROUND

Supercenters, neighborhood stores, shopping clubs, e-commerce, or other channels offer loyalty programs to customers to maintain a customer base and to attract new customers. In many of these programs, a customer may subscribe to the program as a member, and earn reward points or the like for purchasing items. The points may be redeemed for discounts, cash incentives, free products, or other rewards.

### BRIEF SUMMARY

In one aspect, provided is a loyalty transaction system, comprising: a member enrollment confirmation module that determines whether a store customer is a member of a loyalty program offered by the store; a channel determination module that communicates with a database to identify one or more channels available to the store customer for acquiring an item of interest, and determines whether the store customer as a member of the loyalty program uses the one or more channels to acquire the item of interest, the database storing records including data related to the one or more channels, associated customer purchase data, and incentive data corresponding to the channels; a matching module that processes the database records to determine a relationship between the item of interest and the one or more channels for acquiring the item of interest; a point recordation device that associates an incentive with the one or more channels when the item of interest is acquired; and a price comparator that outputs to an electronic device information about purchasing the item of interest from different channels of the one or more channels.

In some embodiments, the loyalty transaction system may further comprise a presence confirmation module that determines a location of the store customer proximal to a channel of the one or more channels; and an analytics engine that determines customer buying habits in response to the determined location provided by the presence confirmation module.

In some embodiments, the channels may include one or more of a supercenter, neighborhood market, club, department store, or online merchant.

In some embodiments, the channels may include one or more store departments.

In some embodiments, the channels may include at least one of a subscription process, auto replenishment, grocery home delivery, small mobile truck selling products, and mobile coffee shops and libraries.

In some embodiments, the information about purchasing the item of interest from different channels may include a discount or special benefit for purchasing from the different channels.

In some embodiments, the point recordation device may associate the incentives with the one or more channels, so that incentives may be accumulated for a particular channel, or across multiple channels.

In another aspect, provided is a computer-implemented method for rewarding a store customer when purchasing an item, comprising: offering multiple channels for purchasing the item, each of the multiple channels including a proprietary computer that stores and processes reward data; consolidating the reward data from the proprietary computers of the multiple channels and formatting the consolidated reward data into a format that is readable by a point of sale system; selecting a channel of the multiple channels; receiving by a loyalty transaction system purchase data from the proprietary computer of the selected channel; providing from the loyalty transaction system to an electronic device of the store customer information about purchasing the item from another channel of the multiple channels.

In some embodiments, the computer-implemented method may further comprise providing an incentive or reward to the customer to purchase the item from the other channel.

In some embodiments, the incentive or reward may include a price of the item at the other channel that is less than a price of the item at the channel.

In some embodiments, the computer-implemented method may further comprise determining that the store customer is present at the store; and determining one or more channels of the multiple channels based on data received in response to determining a location of the store customer.

In some embodiments, the data includes at least one of data about the customer's shopping habits, departments visited by the customer, or frequency or period of time at a location, and wherein the method further comprises determining an incentive or reward based on the data.

In some embodiments, the channels may include one or more of a supercenter, neighborhood market, club, department store, or online merchant.

In some embodiments, the channels include one or more store departments.

In some embodiments, the channels may include at least one of a subscription process, auto replenishment, grocery home delivery, small mobile truck selling products, and mobile coffee shops and libraries

In some embodiments, the offering may include a discount or special benefit for purchasing from the other channel.

In some embodiments, the customer may be a loyalty customer, and may enroll in a loyalty program offered by the store.

In another aspect, provided is a computer-implemented method for cross-channel shopping by a member of a loyalty program, comprising: enrolling a loyalty customer in a loyalty program, data of which is stored at a proprietary computer of at least one channel offering a reward for storage and use at the loyalty program; selecting a first channel for purchasing an item of interest; generating by a loyalty transaction system a link to a proprietary computer of a second channel; converting by the loyalty transaction system a format of reward and purchase data of the first channel to a format that is used to promote a second channel to the loyalty program in response to selecting the first channel; and adding by the loyalty transaction system reward data stored at a proprietary computer of the second channel to the reward data of the first channel.

In some embodiments, the second channel may offer lower pricing with respect to the item of interest than the first channel.

In some embodiments, promoting the second channel may include offering an incentive to the loyalty customer for using the second channel.

### BRIEF DESCRIPTION OF THE SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts.

FIG. 1 is a diagram of a shopping environment in which embodiments may be practiced.

FIG. 2 is a block diagram illustrating functional components of a loyalty transaction system, in accordance with some embodiments.

FIG. 3 is a flowchart of a method for cross-channel shopping by a member of a loyalty program, in accordance with some embodiments.

FIG. 4 is a multi-channel, cross loyalty process flow, in accordance with some embodiments.

### DETAILED DESCRIPTION

Store customers who are part of a consumer loyalty program typically receive as members, incentives, for example, points, discounts, and so on, by purchasing items of interest from a particular store, e-commerce site, or other channel. The loyalty program member may provide a membership card, referred to as a loyalty card, rewards card, points card, credit card, advantage card, club card, or the like, which includes an account number or the like used to associate a purchase with the member, so that the member may accumulate points or other rewards or incentives. A program may have different levels or tiers, each offering different incentives. However, loyalty programs are typically limited to a particular channel, for example, brick-and-mortar purchases only. A reward may include but not be limited to, a gift card, special hours (for example, expanded hours at Disney World), discounts, samples, VIP passes, prizes, and so on.

Embodiments of the present inventive concepts provide systems and methods for establishing or enhancing a customer loyalty program that delivers value to loyalty store customers by offering specific discounts or other incentives from multiple shopping channels, i.e., omni-channel retailing, and establishing cross-channels. Although stores other retail establishments are referred to herein, any business offering an item or service for purchase, rent, lease, or related form of acquisition may equally apply, for example, service providers such as airlines, theme parks, and so on. Other embodiments may include channels across multiple stores having commerce platforms, for example, a shopping mall, superstore, store “club”, small retail store, e-commerce, and/or any other commerce entity where a customer may earn reward points or other membership incentives after purchasing goods or services from one or more channels of the commerce entity. In some embodiments, a store department may offer a loyalty program to its customers. Regardless of store department or more specifically, commerce platform, systems and methods of the inventive concepts may track all purchases made by customers so that all store departments may be accounted for, since products are typically categorized in a store database or the like according to store department. Other customer-related information that can be determined may include channels used or not used, frequency of use, and purpose for using the identified channels. Other channels may relate to a subscription process, auto replenishment, grocery home delivery, a small mobile truck selling products such as an ice cream truck, and mobile coffee shops and libraries

The systems and methods in accordance with some embodiments permit customers to receive offerings to purchase items of interest from multiple commerce entities, or shopping channels of those commerce entities, regardless of whether the customer shops for items or purchases items at one of the channels. Customers who purchase products through different channels made available by a store may suggest that those same customers are candidates for purchasing various services offered by the store, and that highly engaged customers are likely to be “loyal” or repeat customers.

A relevant feature is therefore to encourage a customer to use certain channels and to reward them for using the channels. A use of service may include a purchase of goods or services. When using a service, the crossing of different channels may occur. For example, a customer may purchase items at a store, but request that the items be delivered to the customer's home. This shopping event may cross different departments, for example, purchasing the item at one department and shipping the item by another department. Each department represents a different service regardless of how many products of different types were purchased in that department. Each payment method may be performed by a different channel. Accordingly, there are many ways in which a store customer may interact with goods and services for purchase, each interaction pertaining to a different channel. Also, a customer's loyalty to a store may be established at least in part by the number of channels that the customer uses to purchase items from the store. Accordingly, customers may be rewarded for their loyalty as indicated by the number of channels and/or quantity of purchases made at those channels.

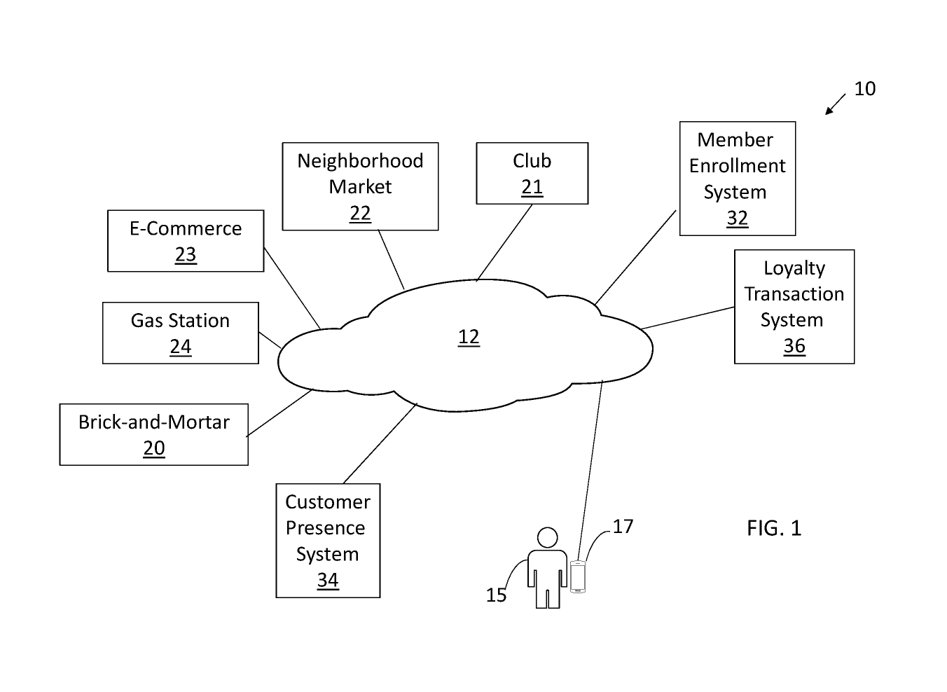

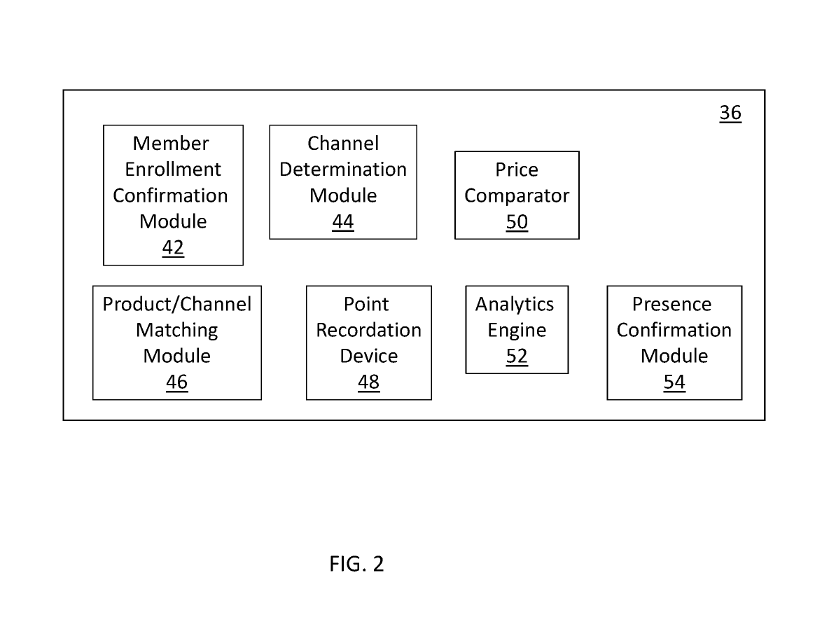

FIG. 1 is a diagram of a shopping environment 10 in which embodiments may be practiced. The environment 10 includes shopping channel or commerce entities that each include at least one electronic device that can communicate with other electronic devices via a network 12. The commerce entities shown in FIG. 1 may include but are not limited to a brick-and-mortar store 20, club 21, neighborhood market 22, e-commerce 23, gas station 24, and/or any other shopping channel from which a customer 15 (also referred to as a member customer) may purchase or otherwise acquire products of interest, and which offers a loyalty program to its member customers. Each commerce entity may have a special-purpose computer for processing in a proprietary manner purchase data, calculating reward points or other incentives, and so on. Other channels not shown or described herein may equally apply, such as web television, kiosks, and so on. The customer 15 can earn points, incentives, rewards, or the like for each channel used by the customer 15, which can be applied to future purchases, or be redeemed for prizes, cash-back, coupons, and so on. As described in FIG. 2, a loyalty transaction system 36 consolidates purchase and reward data from the various commerce entities, regardless of form or proprietary software used for processing purchase or reward data. The loyalty transaction system 36 facilitates data exchanges between sales channel computers, for example, channels 20-24 shown in FIG. 1, to customer smart devices, such as mobile electronic device 17. In particular, all purchases made by a customer entitles the customer to earn points, rewards, or other incentives. This information is consolidated by the loyalty transaction system 36, and formatted for output to the customer mobile device 17, such as a softphone, where the data can be used as part of a purchase made from the mobile device 17, where a customer may user the mobile device 17 to perform a store checkout function while also enjoying the incentive, whether it be stored for future use or redeemed at the time of a current purchase. A combination of channel computers, loyalty transaction system, and customer devices permit a cross-channel loyalty program or the like to be offered.

The brick-and mortar store channel 20, may be a wholesale or retail channel, and may range from large department stores, superstores, or other large physical location where customers may purchase products or services to small footprint locations, such as a gas station, local convenience store, or even vending machines. The store channel 20 may comprise different departments, each offering the same, similar, related, or different items for purchase. The store channel 20 may include well-known elements such as a cashier, self-checkout, scan-and-go, or other purchase-related elements. The brick-and-mortar store channel 20 may offer shipping, for example, shipping products to the customer's home from the brick-and-mortar store channel 20, and so on. Another channel may include a locker or the like for receiving products via an online purchase. Another channel may include gas stations or other businesses where customers may purchase products. Here, gas cards, gift carts, and so on may be used for tracking purchases. Regardless of purchase vehicle or location, purchases may be tracked by systems and methods of the inventive concepts so long as the customer 15 is enrolled in a loyalty program that associates with the purchase vehicle or location.

The e-commerce channel 23 may include websites that permit the customer 15 to purchase items or services. An application may be configured on the customer's mobile electronic device 17, permitting the customer 15 to purchase items or services online from a website or other e-commerce or online merchant facility, and for the customer 15 to use the mobile electronic device 17 to receive from the loyalty transaction system 36 information regarding points or other rewards corresponding to purchases. The loyalty transaction system 36 facilitates data exchanges between the various sales channel computer systems and the customer's mobile electronic device 17. The mobile electronic device 17 may include a store application executed on the mobile device 17 for making purchases from the mobile device 17 in lieu of or in concert with a store POS system, taking into account the reward information.

Items of interest may be purchased using different forms of tender or different forms of payment indicative of different service offering with different channels. For example, different tenders may include but not be limited to gift cards, in-store credit, store credit cards (e.g. Visa®, Mastercard® cards), discount cards, e-wallet, cash, bank account transactions, and so on.

Within a store, different departments may provide one or more channels, for example, apparel, sporting goods, auto services, groceries, general merchandise, electronics, optical, bath and body, hair salon, jewelry, lawn and garden, and so on. A super center may have, for example, over fifty different departments, each offering to the customer 15 sales, discounts, coupons, and so on. Each of these departments may provide a channel that may be used by a customer 15 to earn points for receiving a reward or other incentive. Activity at departments may be tracked, permitting the customer 15 to purchase an item from different departments and for the customer's interactions at the departments to be captured and processed for analytic-related purposes. A customer may purchase an item from a particular department and receive loyalty points or reward by purchasing the item from that department. Rewards or other incentives may be provided based upon the type of checkout processes used for these products, permitting the store 20 to encourage customers to visit multiple departments during a shopping experience.

The multiple channels are available to the customer 15 so that the customer 15 may have options when purchasing goods or services. The customer may be registered with one or more channels, whereby the customer registration information may be processed at the member enrollment system 32. A single store may have multiple channels. Alternatively, multiple stores may have a common channel. The more engaged the customer 15 is at a store, for example, store 20, the higher the loyalty level and more likely the customer 15 will continue to purchase from the store 20.

The member enrollment system 32 processes, accesses, and/or stores loyalty customer enrollment data. When a customer 15 enrolls in a loyalty program, the customer 15 provides personal data such as name, address, date of birth, contact information, and so on. Upon enrollment, the customer 15 receives a loyalty customer identifier that is associated with the customer's account, which may be maintained by the store and/or associated with a bank for credit-related reasons. Enrollment data may be updated, for example, if changes occur to the customer's profile. Loyalty customer identifier, e.g., account number, may be used to associate a purchase with the member customer 15, so that the member customer 15 may accumulate points or other rewards or incentives, regardless of the store channel used to make the purchase. Customer profile information may be collected and stored in a department-specific database, or a store database that associates the customer profile information with a loyalty program offered by the store department.

A customer may register expensive purchases, such as a jewelry purchase. Extended warranties or related purchases may also be made with respect to such purchases. In doing so, this information may be associated with the customer identifier so that the customer may be identified via the customer's club membership card or the like. For example, in embodiments where the customer 15 uses a smart electronic device 17 during a store checkout process, for example, a scan-and-go operation, the customer 15 may be identified via a communication between the mobile electronic device 17 and the loyalty transaction system 36.

The customer presence system 34 determines whether a customer 15 is in the store, and can track the location of the customer 15, for example, by communicating via GPS, WiFi, or other form of electronic communication with an application or program executed at the customer's mobile electronic device 17. Here, a customer 15 may be tracked to capture data about the customer's shopping habits or other data about the customer 15, permitting the system to determine departments where a customer 15 visits, and how frequently. Rewards or incentives can be determined and offered based on the customer's buying habits. In other embodiments, the customer 15 may be identified without the presence system 34, for example, by instead a point of sale (POS) system or the like. In other embodiments, customer shopping and/or buying habit data may be stored at a proprietary computer of one or more other shopping channels 20-23 and received and processed by the customer presence system 34.

FIG. 2 is a block diagram illustrating functional components of the loyalty transaction system 36 of FIG. 1. The loyalty transaction system 36 may comprise a member enrollment confirmation module 42, a channel determination module 44, a product/channel matching module 46, a point recordation device 48, a price comparator 50, an analytics engine 52, and a presence confirmation module 54. Some or all of these elements of the loyalty transaction system 36 may be present under a same computer hardware platform. In other embodiments, these elements may be located on two or more different computer hardware platform, and can communicate with each other and/or other elements of the system via a network or other communication path, for example, wired or wireless signals.

Although not shown, the loyalty transaction system 36 may include at least one special purpose hardware processor and memory that is constructed and arranged to receive and process purchase and/or reward data from one or more proprietary store computers, for example, illustrated in FIG. 1, and to convert the disparate data into a format that can be used by a POS system, smartphone, and/or other electronic device that permits a user to make purchases from the electronic device. For example, although a mobile electronic device 17 such as a smartphone is shown and described, other customer smart devices may equally apply such as Internet of Things (IoT) apparatuses, personal computers, electronic appliances, and so on. One or more elements may be stored in memory and executed by a special purpose hardware device. Although not shown, the loyalty transaction system 36 includes a network interface so that elements of the system 42 may communicate with electronic devices external to the loyalty transaction system 36.

The member enrollment confirmation module 42 may communicate with the member enrollment system 32 or related electronic device to determine whether the customer 15 is enrolled with a customer loyalty program. The member enrollment confirmation module 42 may receive data regarding new or current customer members enrolled in a loyalty program.

The channel determination module 44 includes, or communicates with, a database of channels available the customer 15. Each identified channel may be used by the customer 15 to acquire points or the like as part of a loyalty program, which may result in rewards or other incentives. Channels may be identified by how the customer 15 purchases a product, where the customer 15 spends time in a store, and so on. A list of channels may be compiled based on this data. The channel determination module 44 may also determine when a customer enrolled in the loyalty program uses a particular channel to acquire an item of interest. For example, information derived from the channel determination module 44 may establish when a customer 15 uses a new channel, whereby a different point structure may be implemented, and the customer 15 may receive additional points for using the new channel. The customer 15 may for example be at a particular program level, for example, a “gold level”, and can be upgraded to a “platinum level” if the customer 15 uses a new or different channel. A store or manufacturer may offer new products, items, services, and/or channels to customers, and/or incentives, for using a new or different channel.

The product/channel matching module 46 processes records that include a set of channels and items such as products and/or services that may be acquired via the corresponding channels. In some embodiments, the records include a combination of data related to the one or more channels, associated customer purchase data, and incentive data corresponding to the channels. The records may be stored in a database or other storage device at the loyalty transaction system 36, or at a separate database or storage device in communication with the product/channel matching module 46. The processed records permit the customer 15 to receive information at the mobile electronic device 17, such as special pricing, on a product of interest provided at different channels, and to leverage cross-channel shopping for a particular item. A related benefit is that a store may manage inventory, for example, reducing or eliminating overstock, by providing cross-selling capabilities where items may be purchased from another channel carrying a sufficient inventory of the items.

The point recordation device 48 records points or other reward-related incentive value, and can associate the points with a particular channel, so that points may be accumulated for a particular channel, or across multiple channels.

The price comparator 50 compares the price of an item which may be acquired by multiple channels. The comparison result may be used to establish special pricing by a channel, for providing comparative data to the customer 15, or for other related reasons, for example, so that the customer 15 may be aware of a best price for the item at a particular channel.

The analytics engine 52 identifies which customers are using which channels, and which channels are not being used by a customer. The analytics engine 52 may also identify shopping patterns that will carry over from channel to channel. This may be achieved by the consumer 15 enrolling into a loyalty program which allows analytics engine 52 to track the customer's shopping and/or buying habits, channels used to purchase products, how much time spent by the customer 15 in each department, and so on.

The presence confirmation module 54 determines whether the customer 15 is at or proximal to the channel, for example, store department, where the customer 15 is interested in purchasing an item. To perform these functions, the presence confirmation module 54 may exchange data with the presence system 34, the analytics engine 52, and/or other elements of the environment of FIGS. 1 and 2. For example, data collected by the presence confirmation module 54 may be used by the loyalty transaction system 36 to track customer shopping and/or buying habits along with location so that particular products or services may be offered by other channels, e.g., other store departments, to the customer 15. To determine customer presence, the customer's mobile electronic device 17 may include a GPS device, WiFi triangulation feature, or other location technology that communicates with the presence confirmation module 54. In other embodiments, the customer may establish a presence by using a barcode scanner at a particular location to scan an item of interest, a QR code, and so on, a result of which may likewise be received by the presence confirmation module 54.

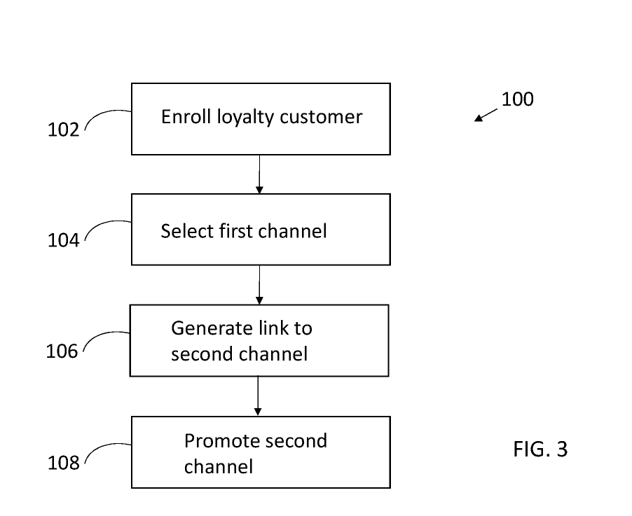

FIG. 3 is a flowchart of a method 100 for cross-channel shopping by a member of a loyalty program, in accordance with some embodiments. Some or all of the method 100 can be performed at the loyalty transaction system 36 of FIGS. 1 and 2, and/or other elements of the environment 10 illustrated in FIG. 1. The method 100 can be governed by instructions that are stored in a memory device of the loyalty transaction system 36 of FIGS. 1 and 2, and/or other elements of the environment 10 illustrated in FIG. 1, and executed by a hardware processor of the loyalty transaction system 36 of FIGS. 1 and 2, and/or other elements of the environment 10 illustrated in FIG. 1.

At block 102, a customer 15 is enrolled in a loyalty program as a loyalty customer. Enrollment information related to the customer 15 may be stored at the member enrollment system 32 and/or loyalty transaction system 36.

At block 104, the customer 15 selects a first channel for purchasing an item of interest. For example, the customer 15 may decide to purchase a bottle of perfume over the counter at a beauty department of a department store.

At block 106, a link is generated to a second channel in response to an activity performed with respect to the first channel. For example, when the customer 15 uses the first channel to purchase a particular item of interest, the loyalty transaction system 36 may determine that the item may be purchased at a lower price than the first channel, or that items related to the purchased item may be purchased at the second channel. At block 108, this information may be used to promote the second channel to the customer 15. This information may be used to trigger the generation of an advertisement regarding the second channel, or other information regarding the second channel that may be provided to the customer 15, for example, output from the price comparator 50 and displayed at the customer's mobile electronic device 17. The promotion of this information may depend on a relationship between the customer 15 and the second channel. For example, historical data may be captured indicating that the customer 15 has performed little or no prior activity at the second channel.

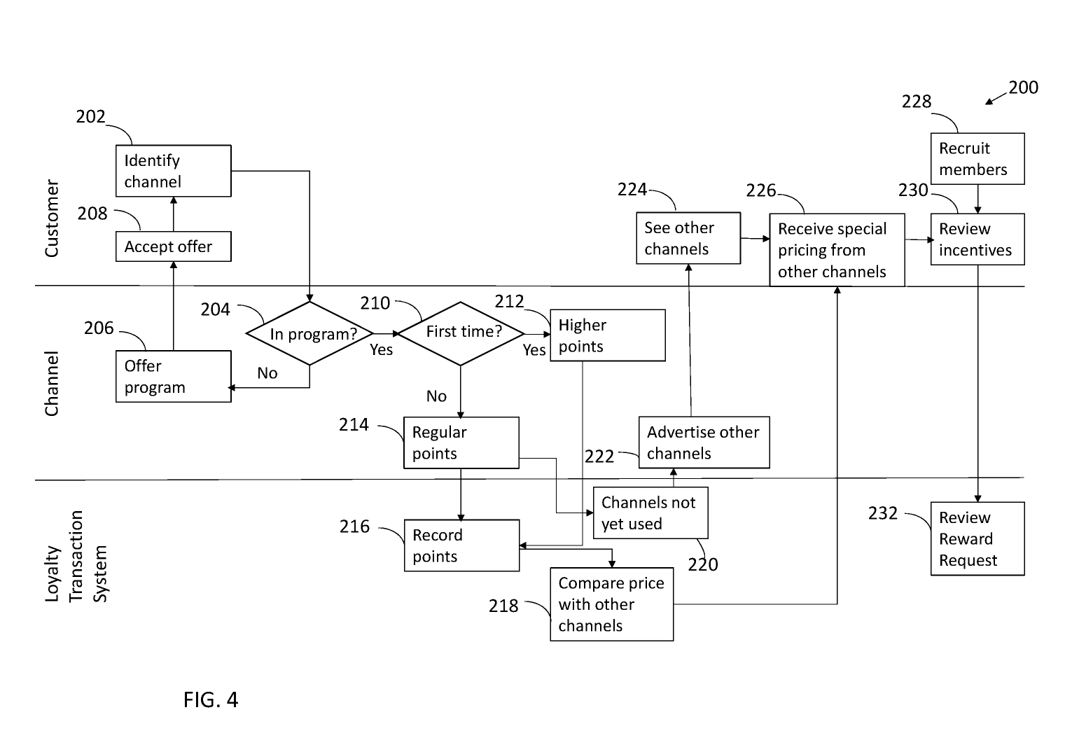

FIG. 4 is a multi-channel, cross loyalty process flow 200, in accordance with some embodiments. In describing the process flow 200, reference is made to FIGS. 1-3. The steps in the process flow 200 are each performed by one of a customer 15, a channel 20-24, for example described herein, and a loyalty transaction system 36. However, one or more steps shown as associated with a customer or a channel may be performed by the loyalty transaction system 36, or other elements of the environment 10 of FIG. 1.

At block 202, a channel is identified where a customer 15 may possibly purchase an item of interest.

At decision diamond 204, a determination is made by the member enrollment confirmation module 42 whether the customer 15 is a member of a loyalty program where the customer 15 may receive points or other incentive for purchasing the item of interest. If the customer 15 is determined to be in the loyalty program, then the method 200 proceeds to decision diamond 210, where a determination is made by the analytics engine 52 whether the customer 15 is a first time user of the channel from which the customer 15 intends to purchase the item of interest. Either the determination at diamond 202 or diamond 210 can be triggered when the customer uses the channel, for example, purchases the item, places the item in a shopping cart, or performs any event that may be detected by a sensor, computer data entry, or other action related to the intended or actual purchase of the item.

If a determination is made at decision diamond 204 that the customer 15 is not a member of the loyalty program, then the method 200 proceeds to block 206, where the customer 15 may receive an offer to join the loyalty program, for example, displayed at the electronic device, or via another communication such as an email message, automated voice message, and so on. At block 208, the customer 215 may accept the offer, whereby the method 200 proceeds to block 202, where the customer 215 may use the channel as a member of the loyalty program.

Returning to decision diamond 210, if a determination is made that the member customer 15 is using the channel for the first time, then the method 200 proceeds to block 212, where the member customer 15 may receive additional points or related incentive value for being a new member. The additional points may be processed (block 216) by the recording device 48, and associated with the channel used by the member customer 15. The purpose for this step is to provide incentives to program participants using a new channel. Otherwise, if the member customer 15 is not a new user of the channel, then the method 200 proceeds to block 212 where the member customer 15 receives points or incentive value typically provided to a regular user of the channel, and recorded (block 216) by the recording device 48.

At block 218, the price of the item purchased or planned to be purchased by the member customer 15 is compared to the price of same item that may be purchased via one or more other channels.

At block 220, the loyalty transaction system 36 tracks channels not used by the customer member 15. At block 222, advertisements or other marketing information may be generated and provided to the customer 15, for example, communicated via email, text, or other electronic communication to the customer's mobile electronic device 17, personal computer, and/or other receiving device regarding additional channels that offer the item of interest or other items that may be of interest to the customer 15. For example, advertisements may be provided to the customer 15, for example, displayed on a screen on the shopping cart or on the mobile electronic device 17 that are relevant to the customer 15 based on data collected by the loyalty transaction system 36, for example, described herein. At block 224, the customer 15 can view information related to the other channels generated at block 222.

At block 226, the customer 15 may receive special pricing or other attractive offering that distinguishes the channel from the previous channel. At block 228, the customer 15 may recruit other customers, or members. In doing so, the customer 15 may receive additional incentives, for example, reward points. At block 230, rewards, incentives, and so on may be generated from data provided by the loyalty transaction system 36. A report or the like that provides incentives may be provided to the customer 15. Accordingly, at block 232, the customer 15 may review a reward request, and receive a notification of rewards, incentives, and so on. The information in blocks 230 and 232 may be accessed via website, device application, for example, a mobile device application, or other interface. Alternatively, the information may be provided to the customer's device 17 and/or other electronic device having a display by email or other form of electronic information, or the customer 15 can retrieve the information from a database or related data storage repository.

For example, the customer 15 may place an item of interest in a shopping cart. As described below in subsequent steps, an alert signal can be generated and provided to the consumer, for example, on a light bulb on the shopping cart, a message displayed on the mobile electronic device 17, or other form of communication, indicating that the item is less expensive if purchased from a different channel. In other embodiments, this notification may occur after a purchase, for example, informing the customer 15 that the customer 15 may purchase the item at a lower price from a different channel in the future.

As will be appreciated by one skilled in the art, concepts may be embodied as a device, system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Computer program code for carrying out operations for the concepts may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Concepts are described herein with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While concepts have been shown and described with reference to specific preferred embodiments, it should be understood by those skilled in the art that various changes in form and detail may be made therein without departing from the spirit and scope as defined by the following claims.

What is claimed is:

1. A computer-implemented method for rewarding a store customer when purchasing an item, comprising:
offering multiple channels for purchasing the item, each of the multiple channels including a proprietary computer that stores and processes reward data;
consolidating the reward data from the proprietary computers of the multiple channels and formatting the consolidated reward data into a format that is readable by a point of sale system;
selecting a channel of the multiple channels;
receiving by a loyalty transaction system purchase data from the proprietary computer of the selected channel;
providing from the loyalty transaction system to an electronic device of the store customer information about purchasing the item from another channel of the multiple channels.

2. The computer-implemented method of claim 1, further comprising:
providing an incentive or reward to the customer to purchase the item from the other channel.

3. The computer-implemented method of claim 2, wherein the incentive or reward includes a price of the item at the other channel that is less than a price of the item at the channel.

4. The computer-implemented method of claim 1, further comprising:
determining by the loyalty transaction system that the store customer is present at the store; and
determining by the loyalty transaction system one or more channels of the multiple channels based on data received in response to determining a location of the store customer.

5. The computer-implemented method of claim 4, wherein the data includes at least one of data about the customer's shopping habits, departments visited by the customer, or frequency or period of time at a location, and wherein the method further comprises determining an incentive or reward based on the data.

6. The computer-implemented method of claim 1, wherein the channels include one or more of a supercenter, neighborhood market, club, department store, or online merchant.

7. The computer-implemented method of claim 6, wherein the channels include one or more store departments.

8. The computer-implemented method of claim 1, wherein the channels include at least one of a subscription process, auto replenishment, grocery home delivery, a small mobile truck selling products, and mobile coffee shops and libraries

9. The computer-implemented method of claim 8, wherein the offering includes a discount or special benefit for purchasing from the other channel.

10. The computer-implemented method of claim 1, wherein the customer is a loyalty customer, and is enrolled in a loyalty program offered by the store.

11. A computer-implemented method for cross-channel shopping by a member of a loyalty program, comprising:
enrolling a loyalty customer in a loyalty program, data of which is stored at a proprietary computer of at least one channel offering a reward for storage and use at the loyalty program;
selecting a first channel for purchasing an item of interest;
generating by a loyalty transaction system a link to a proprietary computer of a second channel;
converting by the loyalty transaction system a format of reward and purchase data of the first channel to a format that is used to promote a second channel to the loyalty program in response to selecting the first channel; and
adding by the loyalty transaction system reward data stored at a proprietary computer of the second channel to the reward data of the first channel.

12. The computer-implemented method of claim 11, wherein the second channel offers lower pricing with respect to the item of interest than the first channel.

13. The computer-implemented method of claim 11, wherein promoting the second channel includes offering an incentive to the loyalty customer for using the second channel.

14. A loyalty transaction system, comprising:
a member enrollment confirmation module that determines whether a store customer is a member of a loyalty program offered by the store;
a channel determination module that communicates with a database to identify one or more channels available to the store customer for acquiring an item of interest, and determines whether the store customer as a member of the loyalty program uses the one or more channels to acquire the item of interest, the database storing records including data related to the one or more channels, associated customer purchase data, and incentive data corresponding to the channels;
a matching module that processes the database records to determine a relationship between the item of interest and the one or more channels for acquiring the item of interest;
a point recordation device that associates an incentive with the one or more channels when the item of interest is acquired; and
a price comparator that outputs to an electronic device information about purchasing the item of interest from different channels of the one or more channels.

15. The loyalty transaction system of claim 14, further comprising:
a presence confirmation module that determines a location of the store customer proximal to a channel of the one or more channels; and
an analytics engine that determines customer buying habits in response to the determined location provided by the presence confirmation module.

16. The loyalty transaction system of claim 14, wherein the channels include one or more of a supercenter, neighborhood market, club, department store, or online merchant.

17. The loyalty transaction system of claim 14, wherein the channels include one or more store departments.

18. The loyalty transaction system of claim 14, wherein the channels include at least one of a subscription process, auto replenishment, grocery home delivery, small mobile truck selling products, and mobile coffee shops and libraries.

19. The loyalty transaction system of claim 14, wherein the information about purchasing the item of interest from different channels includes a discount or special benefit for purchasing from the different channels.

20. The loyalty transaction system of claim 14, wherein the point recordation device associates the incentives with the one or more channels, so that incentives may be accumulated for a particular channel, or across multiple channels.
